(19) United States
(12) Patent Application Publication
(10) Pub. No.: US 2002/0073603 A1
(43) Pub. Date: Jun. 20, 2002

(54) Carrying case for multiple-segment fishing rod

(76) Inventor: David Lefeve, Alexandria, VA (US)

Correspondence Address: MURPHEY & MURPHEY, A.P.C., Pacific Center One, Suite 260, 701 Palomar Airport Road, Carlsbad, CA, 92009-1027, US

(21) Appl. No.: 09/742,464

(22) Filed: Dec. 20, 2000

(51) Int. Cl. A01K 97/08

(52) U.S. Cl. 43/26

(57) ABSTRACT

A segmented fishing rod storage and transport container made of four narrow, elongated, flat, plastic panels arranged in side-by-side configuration, in pairs of opposed panels, and joined along their long side edges, to form a rectangular, cross-sectional, enclosed, container of terminal length having a hollow interior for temporary storage and transport of multiple-segment rods wherein one of the pairs of the panels is wider than the other of the pairs of the panels, each joinder of the panels defined by a radius of curvature to provide a smooth transition from one panel to another about the inside and outside surfaces thereof, and a sealed closure at each of the ends of the container at least one of which is removable to allow a multiple-segment fishing rod to be loaded interior thereof in axial alignment with the panels.

### BACKGROUND OF THE INVENTION

1. Field of the Invention

This invention pertains to the field of sports equipment and to a container in which to carry the equipment. More particularly, the invention is a fishing rod carrying case that is adaptable to be carried in the overhead compartment of commercial airliners and thus outside of the potential hazards of storage in the main storage compartment of the plane.

2. Description of the Prior Art

In our sophisticated society, sports venues are not always located where the sportsperson lives so that travel to those places by land, sea, and air is common. Land and sea are rather slow-moving methods of transportation, so that airline travel has become the vehicle of choice to quickly move the sportsperson to the sporting location in the shortest amount of time. With respect to fishing, the fisherperson often must take one or more airplane routes to get to his or her fishing grounds.

Fishing rods are a mainstay in fishing activity. Normally, fishing rods are of great length, such as 9 to 10 feet, for ocean and fly fishing. Rods of these lengths are extremely difficult to transport in automobiles as well as other land vehicles. Accordingly, rod manufacturers make many of their rods in short, interconnected segments so that they are easier to transport. Modern advances in non-metal composites such as glass, graphite, and boron fibers allow the rod manufacturer to make segmented rods that, when assembled into their full lengths, function as well as a one-piece rod of equal length.

Unfortunately, rod carrying cases have not achieved a similar modernization. The prior art is replete with old-fashioned rod cases which fall into general classes of tubes, panel cases, and oddball shapes. Rod tubes such as U.S. Pat. Nos. 2,473,977; 2,501,270; 2,595,230; 2,650,449; and 5,425,194 are all cylindrical, with various innards that fasten the rods therein for storage. U.S. Pat. No. 2,919,017 discloses a telescoping tube in which to store rods of different lengths. U.S. Pat. No. 2,749,645 discloses a multiplicity of cylindrical tubes in which to store more than one rod.

U.S. Pat. Nos. 2,595,230; 2,650,449; 2,962,187; 3,339,009; 3,678,611; 4,643,302; and 5,425,194 all show plates and fixtures inside the elongated cases on which to fasten the rods or rod segments. U.S. Pat. Nos. 827,736; 3,337,028; and 4,306,601 all disclose paneled cases where the panels unlatch and fold outward to reveal the rods stored inside. Finally, U.S. Pat. Nos. 3,641,0697 and 4,170,801 disclose oddball shapes in which to store rods and reels.

The main problems with cylindrical tubular rod cases is that they may roll about the baggage compartment in the airplane unless secured by adjacent baggage. This rolling around exposes the cases to shocks that can cause the rods inside the cases to tumble, becoming scratched and/or broken. Fisherpersons know, usually from bitter experience, that marred and scratched rods will often break at the defect when placed under tremendous bending stress in fighting a fish. Other problems with cylindrical tube cases include failure to rebound following being struck and dented. To keep the rod cases from rolling about, they are often jammed in between the other baggage on an airplane and shifting baggage often dents the case. Metal cylindrical rod tubes generally will retain dents thus placing the rods inside at risk for additional stress or damage.

Rod cases with internal plates or fixtures on which to fasten rods present a particular problem in that, should the case be dented or stressed, the rods cannot move inside the case to relieve the stress on them and thus are maintained in a stressed position for the duration of the trip. Oddball designed rod cases cannot be stored well with conventional baggage and thus are either left to roll around the storage compartment or to be jammed in between other soft and hard baggage. Odd shaped cases often do not spread stress over a wide area of the case thus allowing the concentrated stress to affect the rods inside.

Therefore, a rod case is needed that can be easily stored in a luggage compartment, will not roll around the compartment, will resist denting and bending; and if dented, will rebound rapidly.

### SUMMARY OF THE INVENTION

This invention is a novel fishing rod case that overcomes the above-mentioned shortcomings in the prior art. It provides added features that make it desirable to use in airplane travel and during fishing. This invention is a rod carrying case made up of four elongated panels joined along their elongated side edges to form a container having a rectangular cross-section and creating an internal volume therein in which to store segmented fishing rods or other short or segmented sports equipment. Each joint along the side edges of the elongated panels is defined by a small radius of curvature to provide a smooth transition from one panel to the next about the outside and inside of the container. A pair of end caps is provided to seal the container where at least one end cap is removable to allow a plurality of segmented fishing rods to be inserted lengthwise into the interior volume of the case.

By far, the most important feature of this invention is that it may be constructed of such a short length that it qualifies as carry-on baggage on commercial airlines. The outside dimensions of the container, i.e., the length, width and height added together and, if the sum is less than a certain amount, e.g., 45 inches, the container will be permitted to be stored in the overhead compartment of nearly all commercial air planes. The flat-walled construction prevents it from rolling back and forth in the compartment and possibly becoming dented by other bags stored nearby. Additionally, passengers seated beneath the overhead storage compartment will not be disturbed by the sounds of rolling cases. Rounded long edges prevent sharp objects, such as wheels and axles of other carry-on luggage, from denting the container and placing stress on the rod segments located inside. Depending upon the length of the segments, this novel case should be no longer than common carry-on luggage so that the owner can relax knowing his or her fishing rods or other sporting device carried inside the container will be free of the hazards to which prior art containers are exposed.

The main object of this invention is a fishing rod or sports equipment case made in a configuration that qualifies it for accommodation as carry-on luggage on commercial airlines. Other objects of the invention include a rod case that will not roll about a compartment when laid on a flat surface; a rod case that contains flat panels joined along curved edges to provide resiliency for relief of stresses and sharp knocks to the exterior thereof; and, a rod case that is easy to handle and store with other baggage.

These and other objects of the invention will become more clear when one reads the following specification, taken together with the drawings that are attached hereto. The scope of protection sought by the inventors may be gleaned from a fair reading of the claims that conclude this specification.

### DESCRIPTION OF THE DRAWINGS

FIG. 1 is a perspective view of the preferred embodiment of the case of this invention;

FIG. 2 is a cross-sectional view taken along lines 2-2 in FIG. 1;

FIG. 3 is a cross-sectional view of another embodiment of this invention;

FIG. 4 is a cross-sectional view of still another embodiment or this invention;

FIG. 5 is a cross-sectional view of taken along lines 5-5 in FIG. 2 showing an end cap in place and in a removed position on the case; and,

FIG. 6 is a plan view of a covering for wrapping about and sealing the rod tube shown in FIG. 1.

### DESCRIPTION OF THE PREFERRED EMBODIMENT

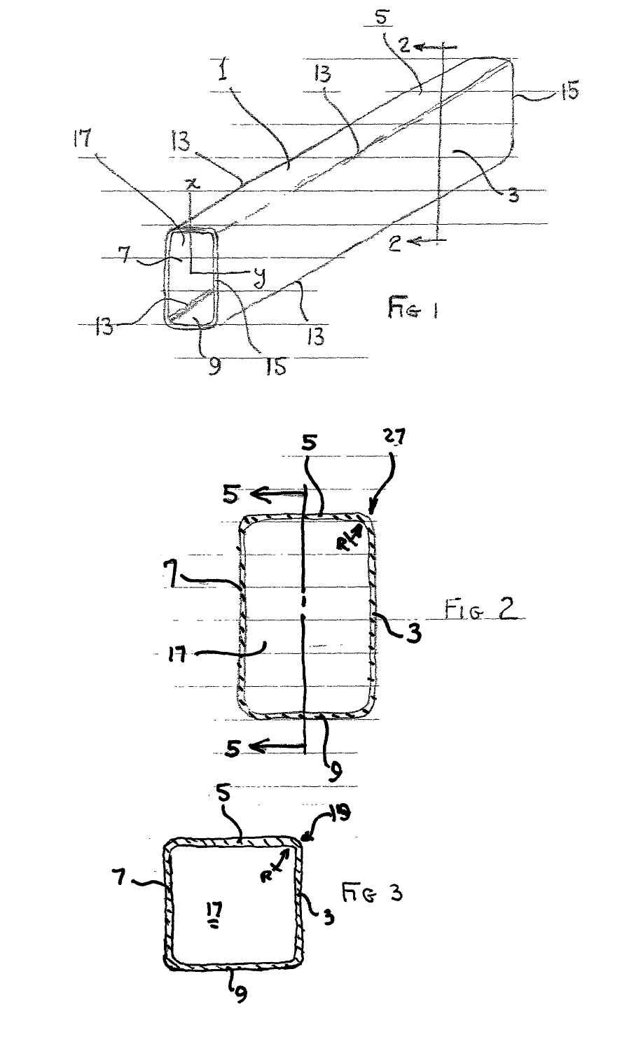

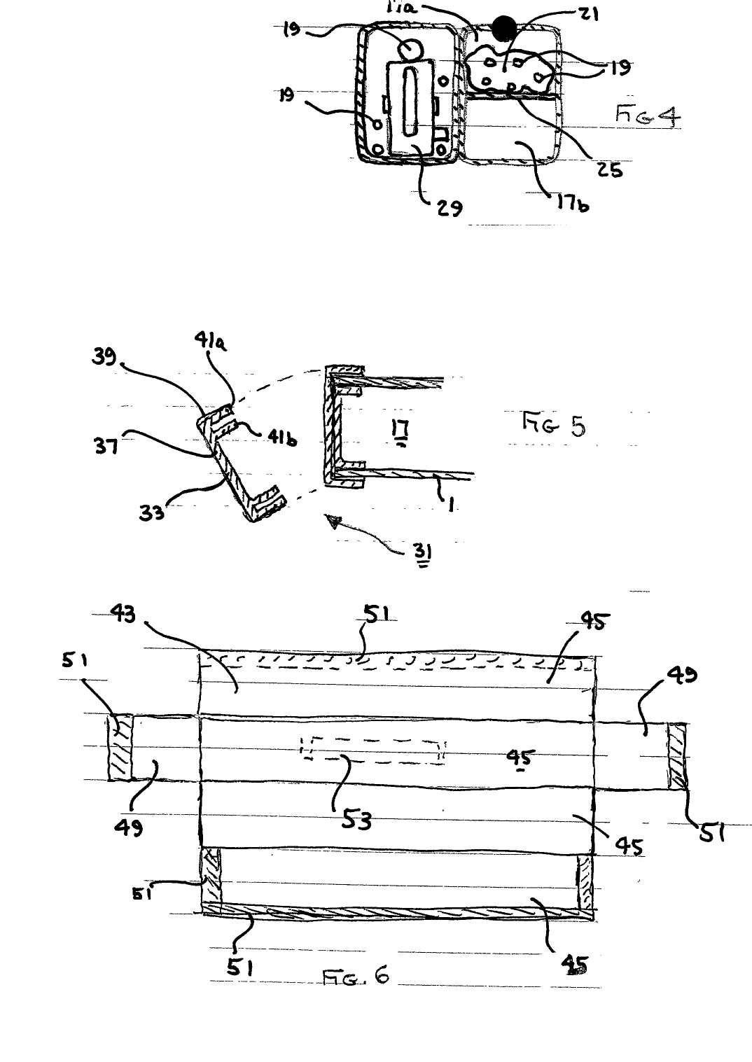

Turning now to the drawings wherein elements are identified by numbers and like elements are identified by like numbers throughout the six figures, FIG. 1 shows the internal assembly or case 1 of the preferred embodiment of this invention and shows a sports equipment or traveling segmented fishing rod container comprising four elongated flat-sided substantially rigid panels 3, 5, 7 and 9, joined together along their respect long side edges 13 to form an elongated container having a rectangular cross-section. The term “substantially” is used in describing the rigid panels because they are subject to slight deformation when jammed between opposed hard objects and the like, however, they remain strong and straight when no so positioned. Each wall panel is terminated by terminal end edges 15 that are preferably arranged in a common plane x-y as shown. Each said panel is made with longer side edges 13 than end edges 15 so that the assembled panels form elongated container 1 having a hollow interior 17. It is into this interior volume that one places his or her segmented fishing rod. The rod segments 19 may be wrapped in a blanket 21 or other soft material to prevent sharp strikes with the interior walls of the cases, as shown in FIG. 4. The interior walls of panels 3, 5, 7 and 9 may be covered with a soft material, or foam, (not shown) to provide the same service. In another embodiment shown in FIG. 4, a separator 25 may be used to separate volume 17 into two or more sub-volumes 17a and 17b so that different items may be stored therein. All of these embodiments are fully contemplated in this invention.

Each flat side panel 3, 5, 7 and 9 is joined to its neighboring adjacent side panel through a radius of curvature 27 shown in some detail in FIGS. 2 and 3. Depending upon the overall size of the case, the radius will vary from ¼ to ½ inch to produce a smooth transition from one panel to the next adjacent panel on both the outside and inside of container 1. This is in contrast to those prior art containers that have sharp corners formed along their length and other prior art containers that have a continuous or cylindrical surface. The sharp edges between flat panels often crimp when dented and this crimp prevents the panels from rebounding to their original shape thus continuing to place stress on the rod segments inside the container. Cylindrical cases also have no incentive to rebound following indentation thus placing great stress on the contents. The flat panels, combined with the rounded corners, provide a significant ability to snap dents outward so that the panels can rebound to their original shape.

The length of panels 3, 5, 7 and 9 should be long enough to accommodate the entire lengths of each segment of the fishing rod. In addition, in certain situations, the rectangular size may be extended to accommodate the fly rod reel 29 attached to one segment 19 of the rod as shown in FIG. 4. This is particularly useful in situations where the fly fisherperson, unfamiliar with eating habits of the fish in a particular stream, would be using a floating fly line and a sinking fly line to determine which particular type of lure or fly to use. Often it is not desirable to re-string one's fishing rod to change from dry flies to wet flies while on the stream. Fisherpersons will take a pre-strung rod for dry flies as well as a pre-strung rod for wet flies. It is not uncommon for a cylindrical rod case containing an unused fly rod to tumble down into the stream and float away. The instant invention presents various flat sides to the case and does not allow tumbling of the case into the water. Thus, the unused rod is safe from floating or tumbling away with the water and being lost to the user.

It is preferred that wall panels 3, 5, 7 and 9 all be extruded as a single unit to provide for a strong container at lower cost than to join separate panels together with glue or the like at a higher cost. The preferred materials in making wall panels are stiff yet yieldable plastic such as polystryrene, polyvinylchloride, acrylonitrile-butadiene-styrene blends, polyvinilidenechloride, rubberized plastics and blends thereof. Extrusion of these plastics and plastic blends to form container 1 are within the prior art and will not be further discussed.

As shown in FIGS. 1, 2 and 3, container 1 may be formed with all four sides or wall panels 3, 5, 7 and 9 being of the same width (FIG. 3), or greater in height than width, or vice versa (FIGS. 1 and 2). Where needed, more than one container may be tied or glued together (FIG. 4) to provide two or more separate compartments such as when one wishes to store more than one segmented rod in said container. It is not uncommon for a fisherperson to take more than one rod to the fishing area. For fly fisherpersons, this often means carrying the rods, in their respective rod cases,

As shown in FIG. 5, end edges 15 are sealed with closure means 31 to prevent the contents from interior container 1 from falling out when container 1 is tipped.

As shown in FIG. 5, closure means 31 may be a molded end cap 33 of the type having a flat closure surface 37 spanning end edges 15 and a fastening perimeter 39, formed about end cap 33, from which a pair of lips 41a and 41b extend orthogonally to the plane of cap 33, in closely spaced-apart arrangement, so that each lip embraces one surface (outer and inner) of end edges 15 to provide closure of the volume and to seal against leakage of water into interior volume 17 should container 1 fall into the water. One closure means 31 is removable from container 1 to allow loading and unloading of rod segments or other items therein. Other types of closure means 31 are available and are contemplated in this invention.

As shown in FIG. 6, it is desirable to encase container 1 in a cover 43. The purposes served by cover 43 include a color, or other means, to be used to identify a particular container to a particular person, a means of softening the outside of container 1 against scratches from contact with other baggage or from dropping it onto a hard surface, a place where the owner's name may be attached, a place where the manufacturer's name may be attached, or a place to provide advertising space for other products.

Cover 43 is shown in FIG. 6 to include a plurality of interconnected elongated panels 45 for application over each of the outside surfaces of side panels 3, 5, 7 and 9, and a pair of end flaps 49 for application over closure means 31. The entire cover is shown as a single unit with mating segments 51 of hook and loop fasteners such as Velcro® (trademark). A carrying strap 53 is sewn or otherwise attached to the outer surface of cover 43 to aid the traveler in transporting container 1.

While the invention has been described with reference to a particular embodiment thereof, those skilled in the art will be able to make various modifications to the described embodiment of the invention without departing from the true spirit and scope thereof. It is intended that all combinations of elements and steps which perform substantially the same function in substantially the same way to achieve substantially the same result are within the scope of this invention.

What is claimed is:

1. A sports equipment container comprising:
a) four narrow, elongated flat, plastic rigid panels arranged in side-by-side configuration and joined along their long side edges to form a rectangular, cross-sectional, enclosed, container of terminal length having a hollow interior for temporary storage and transport of multiple-segment sports equipment;
b) each said joinder of said panels defined by a radius of curvature to provide a smooth transition from one panel to another; and,
c) sealed closure means at each said terminus of said container at least one of which is removable to allow a multiple-segment fishing rod to be loaded therein in axial alignment inside said container.

2. The sports equipment container of claim 1 wherein the length of said container added to the circumference of said container creates a sum within the specification of carry-on luggage of a commercial airline.

3. The sports equipment container of claim 1 wherein two of said four narrow, elongated, flat, plastic panels are arranged in opposed position and form opposite walls in said container and wherein there is at least one right angle between two adjacent panels.

4. The sports equipment container of claim 1 wherein said rigid walls are made from materials selected from the group consisting of polystryrene, polyvinylchloride, acrylonitrile-butadiene-styrene blends, polyvinilidenechloride, rubberized plastics and blends thereof.

5. The sports equipment container of claim 1 wherein said four narrow, elongated, flat, plastic panels arranged in side-by-side configuration and joined along their long side edges form a square, cross-sectional, enclosed, container.

6. The sports equipment container of claim 1 further including a soft cover over all exposed surfaces of said container.

7. The sports equipment container of claim 1 wherein one said sealed closure means is non-removable from said container.

8. The segmented fishing rod storage and transport container of claim 1 further including a removable molded end cap comprising:
a) a planar closure surface spanning said end edges of said container and including a perimeter formed about said end cap;
b) a pair of lips extending orthogonally to said plane of said closure surface, in closely spaced-apart arrangement, so that, when assembled with said container, each said lip embraces one inner or outer surface of said container end edges to provide closure of said interior volume and to seal said volume against leakage of water thereinto.

9. A segmented fishing rod storage and transport container comprising:
a) four narrow, elongated, flat, substantially rigid plastic panels arranged in side-by-side configuration, in pairs of opposed panels, and joined along their long side edges, to form a rectangular, cross-sectional, enclosed, container of terminal length having a hollow interior for temporary storage and transport of multiple-segment rods wherein one of said opposed pairs of said panels is wider than the other said pair of said panels;
b) each said joinder of said panels defined by a radius of curvature to provide a smooth transition from one panel to another about the inside and outside surfaces thereof; and,
c) sealed closure means at each said terminus of said container at least one of which is removable to allow a multiple-segment fishing rod to be loaded in said container in axial alignment with said panels.

10. The segmented fishing rod storage and transport container of claim 9 wherein the length of said container added to the height and width of said container creates a sum within the specification of carry-on luggage of a commercial airline.

11. The segmented fishing rod storage and transport container of claim 9 further including an interior separator to divide said interior volume into separate subvolumes.

12. The segmented fishing rod storage and transport container of claim 9 wherein two of said four narrow, elongated, flat, plastic panels are arranged in opposed position and form opposite walls in said container and having at least one right angle between two adjacent panels.

13. The segmented fishing rod storage and transport container of claim 9 wherein said walls are made from materials selected from the group consisting of polystryrene, polyvinylchloride, acrylonitrile-butadiene-styrene blends, polyvinilidenechloride, rubberized plastics and blends thereof.

14. The segmented fishing rod storage and transport container of claim 9 further including a multiple of said four narrow, elongated, flat, plastic panels arranged in side-by-side configuration, in pairs of opposed panels, and joined along their long side edges, to form a rectangular, cross-sectional, enclosed, container of terminal length having a hollow interior for temporary storage and transport of multiple-segment rods wherein one of said pairs of said panels is wider than the other said pair of said panels in order to hold more than one fishing rod.

15. The segmented fishing rod storage and transport container of claim 9 further including a soft cover over all exposed surfaces of said container.

16. The segmented fishing rod storage and transport container of claim 9 wherein one said sealed closure means is non-removable from said container.

17. The segmented fishing rod storage and transport container of claim 9 further including a removable molded end cap comprising:
a) a planar closure surface spanning said end edges of said container and including a perimeter formed about said end cap;
b) a pair of lips extending orthogonally to said plane of said closure surface, in closely spaced-apart arrangement, so that, when assembled with said container, each said lip embraces one inner or outer surface of said container end edges to provide closure of said interior volume and to seal said volume against leakage of water thereinto.
